(19) United States
(12) Patent Application Publication
(10) Pub. No.: US 2010/0185420 A1
(43) Pub. Date: Jul. 22, 2010

(54) COMPUTER SYSTEM FOR COMPUTING THE MOTION OF SOLID PARTICLES IN FLUID

(76) Inventor: Ejiang Ding, Suwanee, GA (US)

Correspondence Address: EJIANG DING, 1530 Belmont Hills Drive, SUWANEE, GA, 30024, US

(21) Appl. No.: 12/355,789

(22) Filed: Jan. 18, 2009

(51) Int. Cl. G06G 7/57; G06F 17/10

(52) U.S. Cl. 703/2; 703/9

(57) ABSTRACT

The present invention provides a method of computing the motion of solid particles suspended in a fluid comprising: preparing and storing a background flow database containing an inverse evolution matrix and a background field for a given unperturbed computational flow; inputting position and orientation of suspended solid particles; determining projector matrices based on the position and orientation of the suspended solid particles; retrieving reduced space background matrices from the background flow database containing the inverse evolution matrix and the background field for the given unperturbed computational flow; preparing perturbation matrices; and calculating velocity and angular velocity of the suspended solid particles based on the reduced space background matrices and the perturbation matrices.

### BRIEF DESCRIPTIONS OF THE DRAWINGS

FIG. 1(a) is an illustration of the computation domain. FIG. 1(b) is an illustration of the perturbed system with a solid particle suspended in fluid.

FIG. 2(a) is a flow chart for calculation of the motion of the solid particles suspended in fluid in an embodiment of the present invention. FIG. 2(b) shows the structure of the determination device 209 in FIG. 2(a).

### REFERENCES

U.S. PATENTS

| | | | |
|---|---|---|---|
| 4,809,202 | * | Feb. 28, 1989 | Stephen Wolfram |
| 5,432,718 | * | Jul. 11, 1995 | Kim Molvig et al. |
| 5,594,671 | * | Jan. 14, 1997 | Hudong Chen et al. |
| 6,915,245 B1 | * | Jul. 5, 2005 | Frederick L. Hinton et al |

### OTHER PUBLICATIONS

1. H. Happel and H. Brenner, Low Reynolds number hydrodynamics, with special applications to particulate, Noordhoff International Publishing, Lynden, (1973).
2. J. F. Brady and G. Bossis, Stokesian dynamics, Annu. Rev. Fluid Mech. 20, (1988) 111.
3. G. McNamara and G. Zanetti, Use of the Boltzmann equation to simulate lattice-gas automata, Phys. Rev. Lett. 61, (1988) 2332.
4. Y. Qian, D. d'Humières, and P. Lallemand, Lattice BGK models for the Navier-Stokes equation, Europhys. Lett., 51 (1992) 479.
5. H. Chen, S. Chen, and W. H. Matthaeus, Recovery of the Navier-Stokes equations using a lattice-gas Boltzmann method. Phys. Rev. A 45, (1992) R5339.
6. A. J. C. Ladd. Numerical simulations of particular suspensions via a discretized Boltzmann equation. Part 1, J. Fluid Mech., 271 (1994) 285.
7. S. Hou, Q. Zou, S. Chen, and G. Doolen, Simulation of cavity flow by the lattice Boltzmann method, J. Comput. Phys., 118 (1995) 329.
8. X. He, L. -S. Luo, Theory of the lattice Boltzmann method: From the Boltzmann equation to the lattice Boltzmann equation, Phys. Rev. E, 56 (1997) 6811.
9. C. K. Aidun, Y. Lu, and E. J. Ding, Direct analysis of particulate suspensions with inertia using the discrete Boltzmann equation, J. Fluid. Mech. 373 (1998) 287.
10. R. Verberg and A. J. C. Ladd, Simulation of low-Reynolds-number flow via a time-independent lattice-Boltzmann method, Phys. Rev. E 60, (1999) 3366.
11. R. Mei, L. -S. Luo, and W. Shyy, An Accurate Curved Boundary Treatment in the Lattice Boltzmann Method, Journal of Computational Physics 155 (1999) 307.
12. R. Verberg and A. J. C. Ladd, Lattice-Boltzmann Model with Sub-Grid-Scale Boundary Conditions, Phys. Rev. Lett., 84, (2000) 2148.
13. P. Lallemand and L. -S. Luo, Theory of the lattice Boltzmann method: Dispersion, dissipation, isotropy, Galilean invariance, and stability, Phys. Rev. E 61, (2000) 6546.
14. Sauro Succi, The lattice Boltzmann equation for fluid dynamics and beyond, Clarendon Press, Oxford, (2001).
15. N. Q. Nguyen and A. J. C. Ladd, Lubrication corrections for lattice-Boltzmann simulations of particle suspensions, Phys. Rev. E. 66, (2002) 046708.
16. Gilbert Strang, Introduction to Linear Algebra, Wellesley-Cambridge Press: Wellesley, Mass., 3rd edition, (2003).
17. Z. Guo, T. S. Zhao, and Y. Shi, Preconditioned lattice-Boltzmann method for steady flows, Phys. Rev. E 70 (2004) 066706
18. Z. Feng, and E. E. Michaelides, The immersed boundary-lattice Boltzmann method for solving fluid-particles interaction problems, Journal of Computational Physics 195 (2004) 602.
19. J. Kromkamp, D. van den Ende, D. Kandhai, R. van der Sman, and R. Boom, Lattice Boltzmann simulation of 2D and 3D non-Brownian suspensions in Couette flow, Chemical Engineering Science, 61 (2006) 858.

### BACKGROUND OF THE ART

Computation of the motion of solid particles suspended in fluid is important for many applications. A thorough study of the motion of red blood cells and other particles in micro vessels can help us understand the occurrence of various human diseases such as atherosclerosis. An accurate estimation of the force of airflow on an aircraft can directly improve the safety of flights. A correct prediction of the propagation of the solid particle pollution, like the coal ash pollution, is fundamentally important for preventing and solving environmental problems.

The term “fluid” as used herein means various kind of liquid or gas, including but not limited to water, oil, air, vapor, etc, while the term “solid particle” as used herein includes, but is not limited to various kind of solid particles, ranging from small coal ash to big stone and huge aircraft, etc. The task of simulation of particle suspension comprises finding the motion of the fluid and the motion of the solid particles suspended in fluid. In order to simulate a system of particle suspension accurately, the Navier-Stokes equation and the Newtonian equation of motion are used to describe the motion of a fluid and the motion of suspended solid particles, respectively. Navier-Stokes equation is a partial differential equation (PDE) describing the evolution of the local variables (density, velocity, etc.) of the fluid. These local variables are functions of the time (t) and the location (x, y, z) in the computational domain. The Newtonian equation of motion is an ordinary differential equation determining the locations and velocities of the suspended solid particles in the fluid as a function of time. Newton's third law states that the force on the suspended solid particles is equal to the force on the fluid in value and in opposite direction, therefore the motion of fluid is closely related to the motion of the solid particles suspended in the fluid. Usually the two motions are calculated simultaneously. If any one of the two motions is known, the problem of particle suspension is considered as solved, because the other motion can be easily calculated. When used in the following text, the phrase “particle suspension” and “motion of suspended solid particles” are interchangeable.

Finite element methods (FEM), sometimes referred to as finite element analysis, are numerical computational techniques frequently used to find approximate solutions for partial differential equations. For a steady flow the computation is carried out for a macroscopic interval of time ΔT_{FEM}. In FEM the computational domain is divided into many cells. The local variables of the fluid in the cells are expressed by interpolation of the values at the vertexes of the cells. The mesh of the computational domain is constructed according to the configuration of the solid particles in the fluid. As the suspended particles move in the fluid, the computational domain needs to be re-meshed. The re-meshing procedure is a time-consuming procedure and consumes a large portion of the computational time in a FEM simulation.

In the last two decades another numerical method, the lattice-Boltzmann method (LBM) has been developed for direct hydrodynamic simulation. In the lattice-Boltzmann method, the fluid motion is described by the lattice-Boltzmann equation, and the motion of the suspended solid particles is determined by Newtonian equation of motion. It has been proven that in a low-Mach-number flow the lattice-Boltzmann equation can be approximately reduced to the Navier-Stokes equation, thus correctly describing the motion of the fluid. However, the lattice-Boltzmann equation solves time-dependent flow. The state of the fluid and the motion of the suspended solid particles are updated in a very small time step ΔT_{LBM}<<ΔT_{FEM}. For situations where steady-state simulations are sufficient, LBM becomes too expensive computationally.

Compared to LBM, Finite Element Method is more effective in solving the motion of the fluid as long as the steady flow approximation is applicable. If the LBM could efficiently simulate the steady flow, it would provide superior computation speed compared to the FEM. So far, there are two ways to simulate the steady state of fluid in LBM. One is the time-dependent-lattice-Boltzmann approach, where the time-dependent lattice-Boltzmann equation is solved continuously with solid particles unmoved in the fluid until the steady state is reached. The other is the time-independent-matrix approach, where the steady state lattice-Boltzmann equation is converted into a matrix equation, and is then solved using standard matrix methods. For the time-dependent-lattice-Boltzmann approach, even for a very simple system it would take a very long iteration to reach the steady state, which is not affordable in terms of computational time cost, not to mention the difficulty of judging whether the steady state is reached or not. For the time-independent-matrix approach, the computational cost increases very rapidly as the size of the system increases and this approach is not applicable for simulating the motion of solid particles suspended in fluid for a computational domain of realistic size. Intensive efforts have been made to improve the time-dependent-lattice-Boltzmann approach and the time-independent-matrix approach. Unfortunately, neither approach provides efficient and speedy simulation.

Thus, a need still remains for increasing the speed of computing the motion of solid particles suspended in fluid. In view of the ever-increasing pressure of reducing computation costs, improving computation efficiencies and performance, it is critical that answers be found for these problems. Additionally, the need to increase the efficiency of accurately calculating the motion of the red blood cells and other particles in a blood flow, to improve the aircraft flight safety in various atmosphere conditions, to control solid particle pollution in the atmosphere, and to solve many other important solid particle suspension problems, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of computing the motion of solid particles suspended in a fluid comprising: preparing and storing a background flow database containing an inverse evolution matrix and a background field for a given unperturbed computational flow; inputting position and orientation of suspended solid particles; determining projector matrices based on the position and orientation of the suspended solid particles; retrieving reduced space background matrices from the background flow database containing the inverse evolution matrix and the background field for the given unperturbed computational flow; preparing perturbation matrices; and calculating velocity and angular velocity of the suspended solid particles based on the reduced space background matrices and the perturbation matrices.

The present invention provides a system comprising a processor and a storage unit operable to perform operations comprising: preparing and storing a background flow database containing an inverse evolution matrix and a background field for a given unperturbed computational flow; inputting position and orientation of suspended solid particles; determining projector matrices based on the position and orientation of the suspended solid particles; retrieving reduced matrices from the background flow database containing the inverse evolution matrix and the background field for the given unperturbed computational flow; preparing perturbation matrices; and calculating velocity and angular velocity of the suspended solid particles based on the reduced space matrices and the perturbation matrices.

Certain embodiments of the invention have other aspects in addition to or in place of those mentioned above. The aspects will become apparent to those skilled in the art from a reading of the following detailed description when taken with reference to the accompanying drawings.

### BEST MODE FOR CARRYING OUT THE INVENTION

The following embodiments are described in sufficient details to enable those skilled in the art to make and use the invention. It is to be understood that other embodiments would be evident based on the present disclosure, and that method, process, system, or procedural changes may be made without departing from the scope of the present invention.

In the following description, numerous specific details are given to provide a thorough understanding of the invention. However, it will be apparent that the invention may be practiced without these specific details. Likewise, the drawings showing embodiments of the invention are semi-diagrammatic and not to scale and, particularly, some of the dimensions are for the clarity of presentation and are shown exaggerated in the drawings.

Furthermore, various Roman alphabet and Greek alphabet characters and other symbols are used to provide a thorough understanding of the invention. However, it will also be apparent that the invention may be practiced without these specific characters or symbols and may be practiced with another set of characters or symbols.

Also, where multiple embodiments are disclosed and described having some features in common, for clarity and ease of illustration, description, and comprehension thereof, similar and like features one to another will ordinarily be described with like reference numerals.

### 1. Phase 1: Preparing Background Matrices and Database

This section prepares the matrices of the background flow, which will be stored as a database.

The governing equations for particle suspension in fluid are the combination of Navier-Stokes equation, the continuous equation for the fluid, and the Newtonian equations of motion for suspended solid particles. These equations can be written as

$$\begin{matrix}\frac{\partial u}{\partial t} = - ∇ p + μ {∇}^{2} u - u \cdot ∇ u & ( 1 ) \\ ∇ \cdot u = 0 & ( 2 ) \\ m \frac{d V}{d t} = F & ( 3 )\end{matrix}$$

Here u=u(x, t) and p=p(x, t) are the local velocity and the local pressure of fluid at position x and time t, respectively, and μ is the viscosity of the fluid. To shorten the notation in eq.(3) the Newtonian equations of translational and rotational motions have been combined into a single form. The generalized force F stands for the force and the torque exerted on the suspended solid particles, determined by the interaction between the fluid and the suspended solid particles, in addition to external forces. The generalized mass m is a matrix standing for the mass and inertia tensor of the suspended solid particles. The generalized velocity V is the velocity and angular velocity of the suspended solid particles. Defining the total number of the suspended solid particles as Nₚ, the generalized force F and the generalized velocity V of the suspended solid particles include 6Nₚ components in a three-dimensional (3-D) computational domain or 3Nₚ components in a two-dimensional (2-D) computational domain. Here, for simplicity, we consider only the 2-D computational domain, while the generalization to 3-D computational domain is straightforward for those skilled in the art.

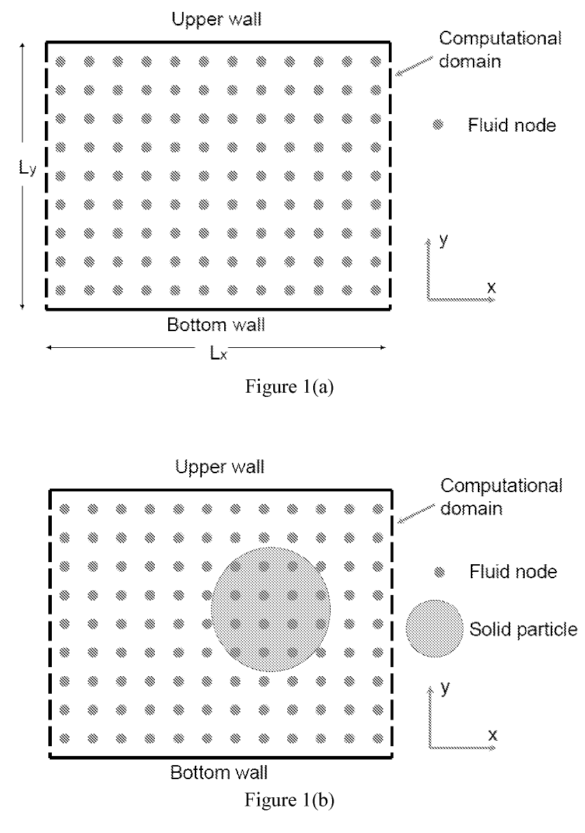

In the lattice-Boltzmann method, the 2-D computational domain is usually discretized as a square grid, and a vertex of the square is called a lattice node. FIG. 1(a) is an illustration of the computation domain. The location of a lattice node x is described by the Cartesian coordinates (x, y) of the lattice node. A fluid node is the lattice node occupied by the fluid in the computational domain. The fluid, consisting of fluid particles, may exist only at the fluid nodes. A fluid particle is a computational element of mass and momentum and should be distinguished from a physical entity like a water molecule.

The state of the fluid is characterized by the distribution function φₖ(x,t), representing the number of fluid particles with basic velocity eₖ at fluid node x and time t. The set of the basic velocities eₖ is discrete and is typically defined as (0,0), (1,0), (1,1), (0,1), (−1,1), (−1,0), (−1,−1), (0,−1), and (1,−1), for k=0 to 8, respectively. The local density ρ(x,t) and local momentum ρ(x,t)u(x,t) at a fluid node x is represented as

$$ρ ( x , t ) = {\sum }_{k = 0}^{8} {ϕ}_{k} ( x , t ) , and ρ ( x , t ) u ( x , t ) = {\sum }_{k = 0}^{8} {e}_{k} {ϕ}_{k} ( x , t ) \qquad ( 4 )$$

respectively, where u(x,t) is the local velocity of the fluid. Although the time, space, and velocity are discrete, the distribution function φₖ(x,t) itself is continuous; hence the local density ρ(x,t) and local momentum ρ(x,t)u(x,t) are continuous, too.

A link connects two adjacent fluid nodes, along the directions of the basic velocity eₖ. The fluid particles may move only along the direction of one of these links. The evolution of the distribution function φₖ(x,t) is determined by lattice-Boltzmann equations (LBE):

$$\begin{matrix}{ϕ}_{k}^{*} ( x , t ) = {ϕ}_{k} ( x , t ) - \frac{1}{τ} [ {ϕ}_{k} ( x , t ) - {ϕ}_{k}^{eq} ( x , t ) ] & ( 5 a ) \\ {ϕ}_{k} ( x + {e}_{k} , t + 1 ) = {ϕ}_{k}^{*} ( x , t ) & ( 5 b )\end{matrix}$$

In eq.(5a) τ is the relaxation time scale and the equilibrium distribution function φₖ^{eq}(x,t) is defined as

$${ϕ}_{k}^{eq} = {w}_{k} ρ [ 1 + 3 {e}_{k} \cdot u + \frac{9}{2} {( {e}_{k} \cdot u )}^{2} - \frac{3}{2} {u}^{2} ] \qquad ( 6 )$$

with ρ=ρ(x,t) and u=u(x,t) the local density and local velocity, respectively. The coefficient wₖ is 4/9 for k=0, 1/9 for k=1, 3, 5, 7, and 1/36 for k=2, 4, 6, 8, respectively. The local density ρ(x,t) can be expressed as the sum of the global density ρ₀ and the local density variation δρ(x,t), i.e. ρ(x,t)=ρ₀+δρ(x,t), where

$${ρ}_{0} = \frac{1}{{N}_{f}} {\sum }_{x} ρ ( x , t )$$

In the above equation N_{f} is the total number of fluid nodes in the computational domain, and the summation is taken over every fluid node. The global density ρ₀ is a constant due to total mass conservation. Both the local density variation δρ(x,t) and the local velocity u(x,t) are small for low-Mach-number flow and the higher order term u(x,t)δρ(x,t) are negligible. The equilibrium state then reads

$${ϕ}_{k}^{eq} = {w}_{k} {ρ}_{0} + δ {ϕ}_{k}^{eq} , \\ δ {ϕ}_{k}^{wq} = {w}_{k} δ ρ + {w}_{k} {ρ}_{0} [ 3 {e}_{k} \cdot u + \frac{9}{2} {( {e}_{k} \cdot u )}^{2} - \frac{3}{2} {u}^{2} ] \qquad ( 7 )$$

A solid wall is an unmovable solid object that located on the border of the computational domain. Solid walls may or may not occupy any fluid nodes. A solid particle is a movable or unmovable solid object that is immerged in the fluid in the computational domain. A solid particle always occupies some fluid nodes in the computational domain. The term “unmovable” means that the location of the fluid-solid interface between fluid and the solid object is fixed. However, the interface itself may move with a constant velocity along the tangential direction, such as a plane plate wall moving parallel to the interface, or “tank-treading” motion of the interface. For simplicity, however, the discussion here will be restricted to a rectangular channel with periodic boundary condition on the x-direction while two parallel solid walls on the top and the bottom of the rectangle, moving in the opposite direction, as shown in FIG. 1(a).

If a solid particle is unmovable and its tangential motion is given, this solid particle is called a “background particle”. On the other hand, a solid particle with velocity or angular velocity to be determined is called a “suspended particle”, or a “solid particle suspended in fluid”. In phase 1 section of the description, only solid walls and background particles exist in the system, and the tangential motion of all walls and unmovable solid particles are given and known. However, in the next phase 2 section of the description, some suspended particles will be added in the system, and the motion of these added solid particles is to be determined.

The fluid particle moving from a fluid node to a solid object will interact with the interface at the midpoint of the link, and return to the fluid node in a lattice-Boltzmann unit time. The surface of a solid object is defined by the midpoints of the links. The shape of the solid surface will become more precise when the lattice grid gets finer. Assume that xᵢ is a fluid node adjacent to a solid wall, and eₖ is the velocity vector from the fluid node to the solid wall. Denote e_{k′}=−eₖ. In the following text, we always denote k′ the opposite direction of k. Dealing with the interaction between the fluid particle and the solid surface, the distribution function φₖ(x,t) evolves to

φₖ(xᵢ,t+1)=φ*_{k′}(xᵢ,t)−6wₖρu_{b}·e_{k′} (8)

and the force exerted on the solid object along this link is

f_{k′}(xᵢ,t+½)e_{k′}=[2φ*_{k′}(xᵢ,t)−6wₖρu_{b}·e_{k′}]e_{k′} (9)

In the above two equations u_{b} is the wall velocity. The fluid-solid interaction scheme used here, including the bounce-back rule eq.(8) for the distribution function φₖ(x,t) and eq.(9) for the force exerted on the solid object along the link, is called the bounce-back scheme. In phase 1 section of the description, the wall velocity u_{b} can only be on the tangential direction on the surface. In the next phase 2 section of the description, the fluid-solid interaction scheme will be applied to the interaction between fluid and a suspended solid particle, and the velocity u_{b} of the fluid-solid interface can be generalized to any direction.

In Stokes flow the equilibrium distribution function φₖ^{eq}(x,t) is reduced from eq.(6) and (7) to

φₖ^{eq}=wₖρ[1+3eₖ·u]

and

φₖ^{eq}=wₖρ₀+δφₖ^{eq} δφₖ^{eq}=wₖ[δρ+3ρ₀eₖ·u] (10)

respectively. For equilibrium state, eq.(4) becomes

$$δ ρ ( x , t ) = {\sum }_{k = 0}^{8} δ {ϕ}_{k}^{eq} ( x , t ) , and {ρ}_{0} u ( x , t ) = {\sum }_{k = 0}^{8} {e}_{k} δ {ϕ}_{k}^{eq} ( x , t ) \qquad ( 11 )$$

It has been noted that LBE becomes simpler if the value of the relaxation time scale is set to τ=1. In fact, with this value of τ=1, the lattice-Boltzmann equation (5a) and (5b) can be reduced to

φₖ(x+eₖ,t+1)=φₖ^{eq}(x,t)

With the notation introduced by eq.(10), the above equation can be rewritten as

δφₖ(x+eₖ,t+1)=δφₖ^{eq}(x,t) (12)

For a rectangular computational domain, as shown in FIG. 1(a), we define the length and height of the domain as Lₓ and L_{y}, respectively, and the total number of the fluid nodes is N_{f}=LₓL_{y}. Since the state of fluid in the computational domain is defined as the set of the distribution functions φₖ(x,t) at every fluid node in the computational domain, and the distribution function φₖ(x,t) at each fluid node is typically expressed by 9 components, the state of fluid in the computational domain can be denoted by a column vector Φ with N_{c}=9N_{f} elements. If both walls are at rest, which means u_{b}=0 in eq.(8), the column vector Φ at time t and t+1 are related by a translation matrix T as

Φ(t+1)=TΦ(t) (13)

where T is a N_{c}×N_{c} matrix. There is only one nonzero element on each row of the translation matrix T while other elements are all zero: Tᵢⱼ=1 if i={x,k}, j={x+eₖ,k}, and both x and x+eₖ are fluid nodes, or i={x,k}, j={x,k′}, and x is a fluid node but x+eₖ is outside of the computational domain (but still inside the walls); and Tᵢⱼ=0 otherwise. For a Stokes flow when the relaxation time scale τ=1, the state of a fluid node can be expressed by three components δρ, ρ₀uₓ, ρ₀u_{y}, i.e., the local density variation, the x-component of the local momentum, and the y-component of the local momentum, respectively. Hence the state of the fluid in the computational domain can also be expressed by a column vector M(t) with Nₘ=3N_{f} components at N_{f} fluid nodes. The Nₘ-dimensional space spanned by the Nₘ components of momentum vector M is called the fluid phase space. Based on eqs.(10) and (11) the vectors Φ and M are related by

Φ=EM M=E⁺Φ (14)

where E and E⁺ are N_{c}×Nₘ and Nₘ×N_{c} sparse matrix, respectively. The elements in E and E⁺ can be easily determined by eqs.(10) and (11), respectively, and eq.(13) can be written as

M(t+1)=E⁺TEM(t)

If the upper and lower walls move at nonzero velocities uₜₒₚ and u_{bottom}, respectively, the above equation is replaced by

M(t+1)=E⁺TEM(t)+E⁺WU_{w} (15)

where U_{w}=(uₜₒₚ,u_{bottom})^{T} is a column vector of 2 elements, called the wall parameter vector, and W is a N_{c}×2 matrix, called the wall matrix. The nonzero elements in the wall matrix W are determined by boundary condition (8). For the system considered here, the bounce-back rule eq.(8) applies to both walls. For the fluid nodes x adjacent to the top wall and links with k′=6 or k′=8, we have 6wₖρ₀=ρ₀/6, hence W_{i,top}=−ρ₀/6 if i={x,6}, or W_{i,top}=ρ₀/6 if i={x,8}. The nonzero elements in the wall matrix W for the fluid nodes adjacent to the lower wall can be similarly obtained. Other elements in the wall matrix W are zero. The steady state M=M(t→∞) satisfies the following equation

(I−E⁺TE)M=E⁺WU_{w} (16)

where I is a Nₘ×Nₘ identity matrix.

Naively, it would have thought that the momentum vector M in eq.(16) could have been obtained by calculating the inverse of the coefficient matrix I−E⁺TE. However, the coefficient matrix is singular, making such a calculation inapplicable. The singularity comes from the undetermined value of the total fluid mass in the system. In order to remove this singularity, an additional constraint of mass conservation must be included. The mass conservation law

$${\sum }_{i = 1}^{{N}_{f}} δ ρ = 0$$

can easily be expressed by a matrix equation

JM=0

where J is a Nₘ×Nₘ matrix with N_{f} nonzero elements. All these nonzero elements are equal, and located on the first row, corresponding to the local density variation δρ(x,t) of each fluid node in the domain. These nonzero elements can be set to one. The singularity in eq.(16) is then removed by adding the mass conservation constraint. The steady state of the system can be written as M₀=M₀^{R}U_{w}, where M₀^{R} is a N_{c}×2 matrix, called the background field. The matrix equation determining the background field M₀^{R} is obtained from eq.(16) with the additional constraint JM=0, that is

AM₀^{R}=E⁺W, A=I−E⁺TE+J. (17)

For a system where fluid is in shear flow produced by two parallel walls moving in opposite directions, the solution is trivial: it is a linear shear flow between the two parallel walls.

The system considered so far is called an unperturbed system. The term “unperturbed system” as used herein means a system without any suspended solid particle. Correspondingly, matrix A in eq.(17) is called the evolution matrix of the unperturbed system. An unperturbed system could be a system of simple shear flow, as we discussed above, but it could also be a much more complex flow. For example, there can be background solid particles, such as an array of unmovable circular cylinders or cubes in the computational domain. Also, a wall can be bump-shaped. Furthermore, the walls and the unmovable solid particles in the system may have “tank-treading”, which means that the normal velocity at any points on the surface must be zero, and only tangential velocity is allowed. All parameters characterizing the motion of the walls and background particles in the unperturbed system are included in the wall parameter vector U_{w}. In these cases the wall parameter vector U_{w} may have more elements, and correspondingly the wall matrices W and the background field M₀^{R} may have more columns.

In the current embodiment of the present invention, we calculate the inverse matrix of the evolution matrix A and the background field M₀^{R}, and store the inverse evolution matrix A⁻¹ and the background field M₀^{R} as a database in a storage unit. It has been unexpectedly discovered that by doing so the calculation of the motion of the suspended solid particle in a fluid will be accelerated greatly.

Finally we note that symmetry property of the unperturbed system can be used to reduce the size of the database, and save the storage resource. For the computational domain shown in FIG. 1(a), the unperturbed system is uniform in the x-direction. To illustrate how this symmetric property can be used, we assume that ζ stands for any component of δρ, ρ₀uₓ, ρ₀u_{y}. Letting i=(x₁, y₁, ζ₁) and j=(x₂, y₂, ζ₂), we denote the element of the inverse evolution matrix A⁻¹ as (A⁻¹)ᵢⱼ. When both x₁ and x₂ increase by the same value, say d, and denoting i′=(x₁+d, y₁, ζ₁) and j′=(x₂+d, y₂, ζ₂), since the unperturbed system is uniform in the x-direction, we have that the element (A⁻¹)_{i′j′} must be equal to (A⁻¹)ᵢⱼ. Therefore, only a factor of 1/Lₓ portion of the inverse evolution matrix A⁻¹ has to be stored in the database.

### 2. Phase 2: Calculation of Perturbation Matrices and Motion of Suspended Solid Particles in Fluid

If there are suspended solid particles in fluid, the positions and the orientations of the suspended solid particles may vary, and the state of fluid nodes may be different from the state before the suspended solid particles are added. Such system is called a “perturbed system”. The term “perturbed system” as used herein means that one or more suspended solid particles are added to the unperturbed system. FIG. 1(b) is an illustration of the perturbed system with a suspended solid particle in fluid.

For a perturbed system, in order to determine the motion of fluid and the motion of the suspended solid particles, more terms need to be added to eq.(17). Some fluid node in the unperturbed system may now be covered by an added suspended solid particle, as shown in FIG. 1(b). We call these nodes covered by suspended solid particle as solid nodes. We define a link connecting a solid node and a fluid node a boundary link. For a boundary link, the velocity u_{b} at a point xᵢ on the surface can be written as

u_{b}=Ũ+Ω×(xᵢ−x_{c})

where Ũ and Ω are the velocity and the angular velocity of the suspended solid particle, respectively, and x_{c} is the inertial center of the suspended solid particle. Here u_{b} may have components both normal and tangential to the surface. From the above equation it can be obtained that

$${u}_{b} \cdot {e}_{{k}^{′}} = ( \begin{matrix}{e}_{{k}^{′}} & {r}_{{k}^{′}}\end{matrix} ) ( \begin{matrix}\tilde{U} \\ Ω\end{matrix} ) \\ {r}_{{k}^{′}} = ( {x}_{i} - {x}_{c} ) \times {e}_{{k}^{′}} \qquad ( 18 )$$

The total force and torque on the suspended solid particle is then written as the summation over all boundary links

\tilde{G}=Σf_{k′}(xᵢ,t+½)e_{k′}

\tilde{T}=Σf_{k′}(xᵢ,t+½)r_{k′}

Using eqs.(9) and (18) we obtain

$$( \begin{matrix}\tilde{G} \\ \tilde{T}\end{matrix} ) = \sum [ 2 {ϕ}_{{l}^{′}}^{*} ( {x}_{i} ) ( \begin{matrix}{e}_{{k}^{′}} \\ {r}_{{k}^{′}}\end{matrix} ) - 6 {w}_{k} {ρ}_{0} ( \begin{matrix}{e}_{{k}^{′}} \\ {r}_{{k}^{′}}\end{matrix} ) ( \begin{matrix}{e}_{{k}^{′}} & {r}_{{k}^{′}}\end{matrix} ) ( \begin{matrix}\tilde{U} \\ Ω\end{matrix} ) ] \qquad ( 19 )$$

and the summation is taken over every boundary links. One may write eq.(19) in the matrix form as

F=QEM+RV (20)

To shorten the notations, vector (Ũ,Ω)^{T} is replaced by the generalized velocity V, and (\tilde{G},\tilde{T})^{T} by the generalized force F. The generalized velocity V is equivalent to the combination of the velocity and angular velocity of the suspended solid particles, and the generalized force F is equivalent to the force and torque on the suspended solid particles. Recalling that Nₚ is the total number of suspended solid particles, both generalized velocity V and generalized force F are column vectors with 3Nₚ elements. In eq.(20) Ω is a 3Nₚ×N_{c} matrix, with a nonzero element for each boundary link, and zero otherwise. R is a 3Nₚ×3Nₚ matrix with all nonzero elements distributed around its main diagonal, and for each suspended solid particle there is a block of 3 columns and 3 rows in the matrix R. Eq.(15) then is replaced by

M(t+1)=E⁺TₚEM(t)+SV+E⁺WU_{w}

Compared to eq.(15), the translation matrix T is replaced by the general translation matrix Tₚ which includes the bounce-back of the distribution function component δφ*_{k′} on the surface of suspended solid particle. The general translation matrix Tₚ and the translation matrix T are equal except for those elements corresponding to the boundary links connecting a fluid node to a solid node. Matrix S in the above equation is a Nₘ×3Nₚ matrix. Nonzero elements in matrix S come from the second term in the bounce-back rule eq.(8). Here only the steady state of the perturbed system is considered, and eq.(17) should be replaced by

(I−E⁺TₚE+J)M−SV=E⁺WU_{w} (21)

When there are external force or torque on the suspended solid particle, eq.(20) in the short notation becomes

F=QEM+RV+F^{ext} (22)

F^{ext} in the above equation is called the generalized external force. For Stokes flow the velocity and angular velocity will immediately relax to the force-free and torque-free values, hence the generalized velocity V of the suspended solid particles is determined by

V=−R⁻¹(QEM+F^{ext}) (23)

Substituting eq.(23) into eq.(21) it is obtained that

(I−E⁺TₚE+J+SR⁻¹QE)M=E⁺WU_{w}−SR⁻F^{ext} (24)

Denoting

A=I−E⁺TE+J (25a)

Aₗ=E⁺(T−Tₚ)E+SR⁻¹QE+Jₚ, (25b)

W₁=−SR⁻¹F^{ext} (25c)

the eq.(24) may be rewritten as

(A+A₁)M=E⁺WU_{w}+W₁ (26)

The definition of the evolution matrix A of the unperturbed system is consistent with eq.(17). The matrix A₁ is a Nₘ×Nₘ matrix, called the perturbation evolution matrix. The additional matrix Jₚ is the virtual fluid mass conservation operator for the suspended solid particles. It should be noted that in the unperturbed system, the fluid at every fluid node can move freely to its neighboring node along any direction of the basic velocity eₖ (except for the bounce-back on the walls). In the case of the perturbed system, the distribution function φₖ(x,t) at a node inside a suspended solid particle represents only ‘virtual fluid’. Because of the bounce-back rule on the fluid-solid interface the virtual fluid must remain inside the suspended solid particle, and the total mass of ‘virtual fluid’ must be conserved. This virtual fluid mass conservation is expressed as JₚM=0, which contains Nₚ independent constraints for Nₚ suspended solid particles. Each constraint restricts the total mass at nodes covered by a suspended solid particle to be a constant. That assures that the total virtual fluid mass at all the solid nodes covered by each suspended solid particle is unchanged.

Solving eq.(26) by inverting the coefficient matrix (A+A₁) would yield the momentum vector M, enabling the calculation of the generalized velocity V using eq.(23).

On the boundary of a suspended solid particle, there are boundary links connecting a fluid node, which is outside of the suspended solid particle, and a solid node which is covered by the suspended solid particle. The nodes at two ends of the boundary link are called fluid boundary node and solid boundary node, respectively. Both fluid boundary nodes and solid boundary nodes are called boundary nodes. Except for solid boundary nodes all other nodes covered by the suspended solid particle is called inside nodes. A₁ is a sparse matrix. It is clear that all nonzero elements in the perturbation evolution matrix A₁ are located in the columns and rows associated with either a boundary node or an inside node. For each boundary node, all elements in the perturbation evolution matrix A₁ corresponding to components (δρ, ρ₀uₓ, ρ₀u_{y}) could be different from zero. For those elements corresponding to the inside nodes, however, only the columns and rows corresponding to the density variation (δρ) can be nonzero (comes from the virtual fluid mass conservation operator Jₚ). If there are bⱼ boundary nodes and dⱼ inside nodes for suspended solid particle j, the perturbation evolution matrix A₁ will include a block around its main diagonal for suspended solid particle j, and the size of the block is nⱼ×nⱼ with nⱼ=3bⱼ+dⱼ. As a result, the perturbation evolution matrix A₁ will consist of Nₚ blocks along its main diagonal, each block standing for one suspended solid particle. Then all nonzero elements in the perturbation evolution matrix A₁ are located on Nₛ columns and Nₛ rows, where Nₛ=Σnⱼ. By eliminating columns and rows with only zero elements, a Nₛ×Nₛ matrix survives. The perturbation evolution matrix A₁ then can be written as

A₁=BCD

where B is a Nₘ×Nₛ matrix and D is a Nₛ×Nₘ matrix. Matrix D is a projector matrix which projects the Nₘ dimensional space to Nₛ dimensions, and matrix B, the transverse matrix of matrix D, also a projector matrix, expands the Nₛ dimensional space to Nₘ dimensions. C is a Nₛ×Nₛ matrix, restricted in the Nₛ dimensional space. This is a subspace of the fluid phase space, called the reduced space.

Eq.(26) then becomes

(A+BCD)M=E⁺WU_{w}+W₁ (27a)

C=DA₁B (27b)

Apply matrix algebra formula

(A+BCD)⁻¹=A⁻¹−A⁻¹B[C⁻¹+DA⁻¹B]⁻¹DA⁻¹

which can be re-written as

(A+BCD)¹=A¹+A¹BHDA¹

H=−(Î+CDA⁻¹B)⁻¹C (28)

where Î is the Nₛ×Nₛ identity matrix. Since

(A+BCD)⁻¹(E⁺WU_{w}+W₁)=(I+A⁻¹BHD)A⁻¹(E⁺WU_{w}+W₁)

we obtain from eqs.(23), (17), and (27a) that

V=−R⁻QEM−R⁻¹F^{ext} (29a)

M=(I+A⁻¹BHD)(M₀^{R}U_{w}−A⁻¹SR⁻¹F^{est}) (29b)

As mentioned before, all nonzero elements in matrix Q correspond to boundary nodes; hence the matrix QEM can be replaced by (QEB)(DM). Denoting \hat{Q}=QEB and \hat{M}=DM, the generalized velocity V of the suspended solid particles can be written as

V=−R¹\hat{Q}\hat{M}−R¹F^{ext} (30a)

On the other hand, we have from eq.(29b) that

\hat{M}=(Î+ÂᵣH)(\hat{M}₀−ÂᵣŜR⁻¹F^{ext}) (30b)

All matrices in the right hand side of eq.(30b) are known; hence the reduced space momentum \hat{M} of the perturbed system can be calculated. In fact, Âᵣ is a matrix of size Nₛ×Nₛ

Âᵣ=DA⁻¹B, (31a)

\hat{M}₀ is a column vector of length Nₛ, called reduced space momentum of the unperturbed system, obtained by

\hat{M}₀=DM₀=DM₀^{R}U_{w}≡\hat{M}₀^{R}U_{w} (31b)

Both Âᵣ and \hat{M}₀^{R}, called the reduced space background matrices, can be retrieved from the database containing inverse matrices A⁻¹ and background field M₀^{R}. Ŝ is a Nₛ×3Nₚ matrix

Ŝ=DS (31c)

And H is a Nₛ×Nₛ matrix which can be calculated as

H=−(Î+CÂᵣ)⁻¹C (31d)

It is noted that the computation of the motion of solid particles suspended in fluid is tied to the computation of the motion of the fluid. To calculate the motion of the solid particle suspended in fluid with prior art methods, the motion of the fluid in the whole computational domain must be calculated simultaneously. However, eqs.(31a)-(31d), as embodied by the present invention, provide a new approach to calculate the motion of solid particle suspended in fluid. We know that from eq.(30b) the reduced space momentum \hat{M} (the components of the momentum in the reduced space) can be obtained from matrix algebraic calculation restricted in the reduced space, and the local density variation and momentum of the fluid at the fluid boundary nodes are obtained. From eq.(30a) the generalized velocity V (the velocity and angular velocity of the suspended solid particles) can now be obtained from the generalized external force F^{est} (the external force and torque on the suspended solid particles) and the reduced space momentum \hat{M} (the components of the momentum in the reduced space), without the need to know the full information of the fluid flow, resulting in greatly accelerated simulation speed.

Recalling that the momentum M is a column vector with Nₘ=3N_{f} components, standing for δρ, ρ₀uₓ, ρ₀u_{y} (the local density variation, the x-component of the local momentum, and the y-component of the local momentum) at each fluid node, the momentum M includes the full information about the fluid motion. Because the motion of the suspended solid particles is known, when the motion of fluid in the whole computational domain is required, the momentum M of the perturbed system can be calculated easily. In the present situation the momentum M of the perturbed system can be obtained from eq.(29b).

The method is applicable to a system where some components of the motion of the suspended solid particle are given and the other components are to be determined. In this case, the term SV in eq.(21) should be replaced by SV+S₁V₁, where V₁ stands for the known components of the motion of the suspended solid particles and S₁ for the corresponding perturbation matrix, and V stands for the to-be-determined components of the motion of the suspended solid particles and S for the corresponding perturbation matrix. Eq.(21) becomes

(I−E⁺TₚE+J)M−SV=E⁺WU_{w}+S₁V₁ (21a)

Then a similar procedure from eq.(21) through eqs.(31) follows.

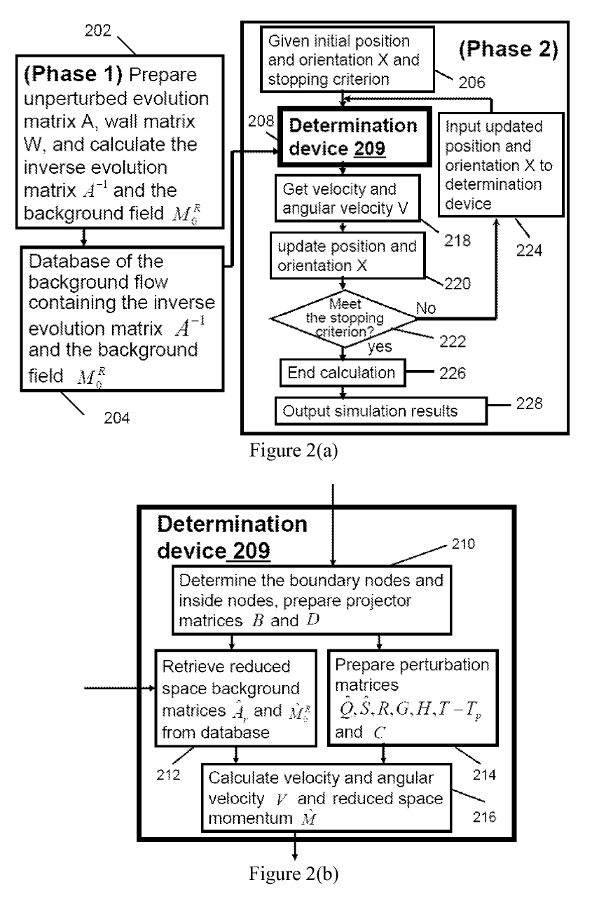

Now referring to FIG. 2(a) wherein it is shown a flow chart for calculation of the motion of the solid particles suspended in fluid in an embodiment of the present invention.

Phase 1 of the simulation consists of a step 202 and a step 204.

In the step 202, the problem of the unperturbed system is solved by solving eq.(17). The resulting inverse evolution matrix A⁻¹ and the background field M₀^{R} are obtained. These computations could be carried out by a processor in a computer or by other computing apparatus.

In the step 204, the inverse evolution matrix A⁻¹ and the background field M₀^{R} are stored as a background flow database. The background flow database could be stored in a computer memory unit or a computer hard disk drive unit. The background flow database could also be stored in other storage unit from which the inverse evolution matrix A¹ and the background field M₀^{R} could be wholly or partially retrieved. The background flow database that stores the inverse evolution matrix A⁻¹ and the background field M₀^{R} will be used for the calculation of the velocity of suspended solid particles in Phase 2.

Phase 2 of the simulation consists of several steps and the procedure is explicated below.

In a step 206, the initial generalized position X (the initial values of the positions and orientations of the suspended solid particles) and a stopping criterion are given. In a step 208, the information given in the step 206 is inputted into a determination device 209. Also information in the inverse evolution matrix A⁻¹ and the background field M₀^{R} are inputted into the determination device 209 from the background flow database. The determination device 209 is a process that calculates the generalized velocity V of the suspended solid particles and the reduced space momentum \hat{M} of the perturbed system.

In a step 218, the generalized velocity V is outputted from the determination device 209. In a step 220, the generalized position X of the suspended solid particles is updated by using the generalized velocity V outputted in the step 218. The generalized position X of the suspended solid particles can then be determined by solving a set of differential equation,

$$\frac{d X}{d t} = V ( X )$$

This equation can be solved readily and quickly by currently existing standard numerical methods such as Euler method or Runge-Kutta algorithm.

In a step 222, a determination is made as to whether to stop the simulation according to the stopping criterion given in the step 106. If the stopping criterion is not met yet, a step 224 will follow. In the step 224, the updated generalized position X of the suspended solid particles is inputted into the determination device 209 and the step 208 will repeat itself. If the stopping criterion is met, a step 226 will follow. In the step 226, the simulation is ended.

The step 206, 208, 218, 220, 222, 224, 226 could be performed by a processor and a memory unit of a computer or other computing apparatus.

A step 228 will follow the step 226. In the step 228, the simulation results are outputted. The simulation results could be outputted to a storage unit and be stored in the storage unit. The simulation results could also be outputted to a display device that displays the motion of the solid particles suspended in the fluid.

After the step 228 where the simulation results are outputted, users will be able to utilize the simulation results for their intended tasks and purposes such as, but not limited to, forming image streams visualizing how red blood cells traverse the blood vessels, how particulate pollutant traverse in air or water, and how an airplane traverse the atmosphere, etc. The simulation results can also be used to calculate the motion of the fluid in the whole computational domain.

The determination device 209 in FIG. 2(a) in the step 208 comprises several steps. FIG. 2(b) shows the detailed structure of the determination device 209 in FIG. 2(a).

The determination device 209 comprises the following steps:
1. Constructing the projector matrices B and D based on the current position and orientation of the suspended solid particles, in a step 210;
2. Retrieving reduced space background matrices Âᵣ and \hat{M}₀^{R} from the background flow database, the reduced space background matrices Âᵣ and \hat{M}₀^{R} being a part of the inverse evolution matrix A⁻¹ and background field M₀^{R} stored in the background flow database, in a step 212;
3. Determining the perturbation matrices in a step 214; the perturbation matrices including \hat{Q}, Ŝ, R⁻¹, Tₚ−T, C, and H;
4. Calculating the reduced space momentum \hat{M} using eq.(30b), and the generalized velocity V of suspended solid particle using eq.(30a), in a step 216.

The step 210, 212, 214, and 216 define the velocity and angular velocity V(X) of the suspended solid particles as a function of position and orientation of these particles X.

It should be noted that the perturbation matrices \hat{Q}, Ŝ, R⁻¹, Tₚ−T, C, and H referred to in the step 214 are for the bounce-back scheme. When the interaction between fluid particle and solid wall surface is described by interpolation bounce-back scheme, or sub-grid-scale scheme, or immersed boundary condition scheme, or other schemes, the distribution function φₖ(x,t) will change according to equations different from eqs.(8) and (9), and the perturbation matrices should be changed accordingly. However, the determination device 209 works for all these different schemes. An example of such application is described in the next section.

Usually, in a realistic system, Nₛ/Nₘ≈10⁻², this means that the computational time for calculating inverse matrix (Î+CÂᵣ)⁻¹ as embodied by the present invention is 10⁶ times smaller than (a million times faster than) the computational time for directly calculating inverse matrix (A+A₁)⁻¹, as used in prior art methods. Even at high concentration of particle suspension, we have Nₛ/Nₘ≈10⁻¹, and the present invention will calculate the motion of the suspended solid particle a thousand times faster than prior art methods do. Thus it has been discovered that the present invention greatly accelerates the speed of the calculation of the motion of solid particles suspended in a fluid.

In fact, with carefully coding the procedure of calculation, the reduced momentum \hat{M} can be obtained by solving a set of linear algebraic equations with Nₘ unknowns without actually inverting matrix (Î+CÂᵣ), resulting in even greater speed and time-saving of the simulation.

The method presented here can also be used for preparing the background flow database if a similar but slightly different background flow database had already been obtained. For example, let's assume that one system (system Γ_{A}) is a rectangular channel with periodic boundary conditions in the x-direction and two parallel walls on the top and bottom of the domain, respectively, and another system (system Γ*_{A}) is similar to system Γ_{A} except that a fixed circular cylinder is located at the center of the channel. If the inverse matrix A⁻¹ and the background field M₀^{R} for system Γ_{A} are known, the system Γ_{A} can be considered as the “unperturbed system”, and the inverse matrix A′⁻¹ and the background field M′₀^{R} for system Γ*_{A} can be obtained by using the method just described in this section by considering system Γ*_{A} the “perturbed system”. A person with ordinary skill in the art should find it straightforward to carry out such a calculation. In so doing, background flow databases for different configurations of the computational domain could be constructed using already constructed background flow databases without having to be constructed from scratch. This will further increase the simulation speed for different configurations of the computational domain.

In some situations, the motion of the movable solid particles is restricted to a small region of the whole computational domain, the calculation at the phase 2 will require only a limited portion of the inverse matrix A⁻¹ and the background field M₀^{R}. In such a case, the background flow database may be divided into several sub-databases, and only one or more sub-databases will be used for the phase 2 simulation.

The matrix equations (17) and (27) are obtained within the framework of lattice-Boltzmann method. However, a Partial Differential Equation (PDE) in general could be solved by a “finite differential method”. In such a method the PDE is converted into a set of linear algebraic equations in discrete time and space. Hence the present invention is also applicable to finite differential method or finite volume method.

It should also be noted that the exact formulation of the perturbation matrices as presented in the present invention could be substituted by an approximation to further improve the speed of the simulation. Furthermore, a hybrid method combining the present method and an approximation method could also be used to improve the speed of the simulation. A person with ordinary skills in the art should find it straightforward to utilize the present invention in these different variations.

In some investigations when a Navier-Stokes flow (nonzero Reynolds number flow) is considered, the solution may be expressed as a series expanded at zero Reynolds number. In such a scenario, the present invention is applicable in calculating the zeroth order term in this series, and higher order terms will be obtained based on the zeroth order term obtained using the present invention.

Thus it has been discovered that the present invention provides an accurate, fast, efficient, and versatile solution to the problem of particle suspension in fluid. These and other valuable aspects of the present invention consequently further the state of the technology to at least the next level.

Thus, it has been discovered that the computing method and the computer system of the present invention furnishes important and heretofore unknown and unavailable solutions, capabilities, and functional aspects for increasing computation speed, improve simulation efficiency, reducing complexity, and reducing cost for the simulation of solid particles suspension in fluid. The resulting processes are straightforward, cost-effective, uncomplicated, unobvious, and highly versatile and effective.

### 3. Lubrication Force

In order to show that the determination device 209 works for different fluid-solid interaction schemes, let's consider the application of the present invention in solving a particle suspension system with lubrication force.

In lattice-Boltzmann method the hydrodynamic force between two surfaces are calculated by patching the leading term of the lubrication force onto the force determined by the lattice-Boltzmann model. By slightly modifying the formulation presented so far the lubrication force could be included in the determination device 209. For simplicity we consider the lubrication force between two circles. This method can be extended to other particle shapes. Assuming that particle i and particle j are in near contact, according to the lubrication theory the force between the two circles is

fᵢ^{1ub}=−fⱼ^{1ub}=−κᵢⱼ(Uᵢⱼ·gᵢⱼ)gᵢⱼ (32)

where fᵢ^{1ub} is force on particle i, and fⱼ^{1ub} is force on particle j, Uᵢⱼ=Uᵢ−Uⱼ is the relative velocity between particle i and particle j; gᵢⱼ is the unit vector from the contact point on surface of particle i to the contact point on surface of particle j. The coefficient κᵢⱼ is dependent on the radius of both particle i and particle j at the contact point.

κᵢⱼ=λ₁r_{c}^{3/2}[εᵢⱼ^{-3/2}(1+λ₂εᵢⱼ/r_{c})−δ^{-3/2}(1+λ₂δ/r_{c})] if εᵢⱼ<δ (33a)

κᵢⱼ=0 if εᵢⱼ≧δ (33b)

εᵢⱼ is the gap between the two contact points, r_{c}=rᵢ+rⱼ, where rᵢ and rⱼ are the radius of the two circles, respectively, and λ₁ and λ₂ are two constants defined as

λ₁=\sqrt{2}π/16≈0.27768 λ₂=3.85 (34)

and δ=2 is a cut-off distance. This formula could be written in a different form as

fᵢ^{1ub}=−κᵢⱼ(Uᵢ·gᵢⱼ)gᵢⱼ+κᵢⱼ(Uⱼ·gᵢⱼ)gᵢⱼ (35)

If there are Nₚ particles the lubrication force on particle i could be obtained by taking summation over all particles from j=1 to Nₚ except for j=i. Then the total lubrication force is calculated as F^{1ub}=GV, which can be written as follows:

$$( \begin{matrix}{F}_{1}^{x} \\ {F}_{1}^{y} \\ {T}_{1}^{z} \\ {F}_{2}^{x} \\ {F}_{2}^{y} \\ {T}_{2}^{z} \\ ⋮\end{matrix} ) = ( \begin{matrix}{G}_{11}^{xx} & {G}_{11}^{xy} & 0 & {G}_{12}^{xx} & {G}_{12}^{xy} & 0 & … \\ {G}_{11}^{yx} & {G}_{11}^{yy} & 0 & {G}_{12}^{yx} & {G}_{12}^{yy} & 0 & … \\ 0 & 0 & 0 & 0 & 0 & 0 & … \\ {G}_{21}^{xx} & {G}_{21}^{xy} & 0 & {G}_{22}^{xx} & {G}_{22}^{xy} & 0 & … \\ {G}_{21}^{yx} & {G}_{21}^{yy} & 0 & {G}_{22}^{yx} & {G}_{22}^{yy} & 0 & … \\ 0 & 0 & 0 & 0 & 0 & 0 & … \\ ⋮ & ⋮ & ⋮ & ⋮ & ⋮ & ⋮ & ⋰\end{matrix} ) ( \begin{matrix}{U}_{1}^{x} \\ {U}_{1}^{y} \\ {Ω}_{1}^{z} \\ {U}_{2}^{x} \\ {U}_{2}^{y} \\ {Ω}_{2}^{z} \\ ⋮\end{matrix} ) \qquad ( 36 )$$

In the above equation

$$\begin{matrix}{G}_{ij}^{ab} = {κ}_{ij} {g}_{ij}^{a} {g}_{ij}^{b} & if i \neq j \\ {G}_{ii}^{ab} = - {\sum }_{k \neq i} {κ}_{ik} {g}_{ik}^{a} {g}_{ik}^{b} & if i = j\end{matrix}$$

where a and b stand for x or y. Many elements in the matrix G are zeros because the particles are circles and the tangential components of the lubrication forces have been neglected. If the solid particles are not circles, the normal components of the lubrication force along gᵢⱼ will result in torques on the particles, and eq.(36) will include more nonzero components on the right hand side.

The above calculation for the lubrication force applies to the interaction between two suspended solid particles, or between a background solid object and a suspended solid particle. When lubrication forces between suspended solid particles are considered, matrix G should be added to the matrix R. Then, eq.(30a) and eq.(30b) should be modified as the following:

V=−(R+G)⁻¹\hat{Q}\hat{M}−(R+G)⁻¹F^{ext} (37a)

\hat{M}=(Î+ÂᵣH)[\hat{M}₀−Â, Ŝ(R+G)⁻¹F^{est}] (37b)

Consequently, the matrix R in the step 214 in FIG. 2(b) should be replaced by (R+G). The matrix G is also one of the perturbation matrices.

### 4. Application of the Present Invention

The formulation of the present invention is demonstrated by using a specific embodiment for illustration. However, the application of the present invention can be extended to more general situations, as listed but not limited to:
The method works whenever an external force is exerted on the suspended solid particle, or a body force is exerted on fluid.
Formulation presented here is for 2D case, but it can be easily generalized to a 3D version.
The examples presented here have computational domain having periodic boundary condition on the x-direction and two no-slip walls on the y-direction.

However, the boundary condition of the computational domain may be replaced by other boundary conditions, such as the free-stress boundary condition, the free-slip boundary condition, or other boundary conditions.
The method works for walls with bumps.
The method is applicable to multiphase flow.
The method is applicable to any shape of fluid-solid boundary, either regular or irregular.
The method is applicable to rigid particles as well as deformable particles.
The method is applicable to finite differential method or finite volume method, as long as the re-mesh procedure is not necessary.

We may list more cases where the present invention works. Nevertheless, while the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hitherto fore set forth herein or shown in the accompanying drawings are to be interpreted in an illustrative and non-limiting sense.

What is claimed is:

1) A method of computing the motion of suspended solid particles in a fluid comprising:
preparing and storing a background flow database containing an inverse evolution matrix and a background field for a given unperturbed computational flow;
inputting position and orientation of suspended solid particles;
determining projector matrices based on the position and orientation of the suspended solid particles;
retrieving reduced space background matrices from the background flow database containing the inverse matrix and the background field for the given unperturbed computational flow;
preparing perturbation matrices; and
calculating velocity and angular velocity of the suspended solid particles based on the reduced space background matrices and the perturbation matrices.

2) The method as claimed in claim 1 wherein preparing the perturbation matrices includes preparing perturbation matrices \hat{Q},Ŝ,R,H,T−Tₚ and C.

3) The method as claimed in claim 1 wherein retrieving reduced space background matrices includes retrieving reduced space background matrices Âᵣ and \hat{M}₀^{R}.

4) The method as claimed in claim 1 wherein preparing the perturbation matrices \hat{Q},Ŝ,R,H,T−Tₚ and C includes preparing an additional perturbation matrix G for system involving lubrication force in which case R is substituted by R+G.

5) The method as claimed in claim 1 wherein calculating velocity and angular velocity V of the suspended solid particles includes calculating the velocity and angular velocity V in terms of the reduced space momentum \hat{M} and the external force and torque on the suspended solid particles F^{est}, through an equation such as V=−R¹\hat{Q}\hat{M}−R¹F^{est}, and calculating the reduced space momentum \hat{M}, in the reduced space, according to an equation such as \hat{M}=(Î+ÂᵣH)(\hat{M}₀−ÂᵣŜR⁻¹F^{ext}), without calculation of the momentum vector M in the fluid phase space.

6) The method as claimed in claim 1 further comprising:
inputting a stopping criterion;
outputting the velocity and angular velocity V of the suspended solid particles;
updating the position and the orientation of the suspended solid particles;
repeating steps in claim 1 of inputting position and orientation of the suspended solid particles, determining projector matrices, retrieving reduced space background matrices, preparing perturbation matrices, and calculating velocity and angular velocity of the suspended solid particles, until the stopping criterion is met.

7) The method as claimed in claim 1 further comprising:
ending the simulation; and
outputting the position and the orientation of the suspended solid particles.

8) The method as claimed in claim 1 wherein preparing the background flow database includes preparing a background flow database for a steady flow fluid with various shapes of two and higher dimensional computational domain, examples of which are two parallel plane walls, wavy walls, walls with bumps, domain with unmovable solid objects, etc.

9) The method as claimed in claim 1 wherein preparing the background flow database includes preparing a background flow database for a steady flow fluid with various boundary conditions, such as a periodic boundary condition, a free-slip boundary condition, a no-slip boundary condition, a stress-free boundary condition, a constant-velocity boundary condition, etc, or a combination of the several different boundary conditions.

10) The method as claimed in claim 1 wherein preparing the background flow database includes using symmetry property of the unperturbed system to reduce the size of the database.

11) The method as claimed in claim 1 wherein preparing the background flow database includes saving the pre-calculated inverse evolution matrix A⁻¹ and the background field M₀^{R} in a database, which could be stored in a memory unit or a hard drive of a local computer or other storage apparatus, or on a server on the internet, the database being capable of being shared with other simulation missions.

12) The method as claimed in claim 1 wherein preparing the background flow database includes storing sub-databases obtained by dividing the background flow database into several parts, the sub-databases being used for simulating the motion of movable solid objects existing only in a restricted region of the computational domain.

13) The method as claimed in claim 1 wherein preparing the background flow database includes calculating an new inverse evolution matrix A′⁻¹ and a new background field M′₀^{R} based on the inverse evolution matrix A⁻¹ and the background field M₀^{R} prepared for a similar but different background flow.

14) The method as claimed in claim 1 wherein inputting the position and orientation of the suspended solid particles includes inputting the position and orientation of the suspended solid particles manually, or by executing a computational code, or by scanning graphic in prepared documents.

15) The method as claimed in claim 1 wherein inputting the stopping criterion includes inputting the criterion for position and orientation of the suspended solid particles, or for the configuration of the suspended solid particles, or for the condition of the fluid field, or for any criterion based on the demand of the simulation.

16) The method as claimed in claim 1 wherein preparing the perturbation matrices includes preparing perturbation matrices for systems involving different fluid-solid interface interaction rule, such as the interpolated bounced-back scheme, or the sub-grid-scale scheme, or immersed boundary condition scheme, or other schemes.

17) The method as claimed in claim 1 further comprising:
applying the method to solve a partial differential equation by converting such a partial differential equation into a matrix equation.

18) The method as claimed in claim 1 further comprising:
using the present method to calculate the zeroth order term of an expansion for a solution of Navier-Stokes flow at the zero Reynolds number.

19) A system comprising a processor and a storage unit operable to perform operations comprising:
preparing and storing a background flow database containing an inverse evolution matrix and a background field for a given unperturbed computational flow;
inputting position and orientation of suspended solid particles;
determining projector matrices based on the position and orientation of the suspended solid particles;
retrieving reduced space background matrices from the background flow database containing the inverse evolution matrix and the background field for the given unperturbed computational flow;
preparing perturbation matrices; and
calculating velocity and angular velocity of the suspended solid particles based on the reduced space background matrices and the perturbation matrices.

20) The system as claimed in claim 19 further comprising a display unit operable to be caused by the processor to show the results of the simulation.
